(19) United States
(12) Patent Application Publication
(10) Pub. No.: US 2023/0264352 A1
(43) Pub. Date: Aug. 24, 2023

(54) ROBOT DEVICE FOR DETECTING INTERFERENCE OF CONSTITUENT MEMBER OF ROBOT

(71) Applicant: FANUC CORPORATION, Yamanashi (JP)

(72) Inventor: Takashi YAMAZAKI, Yamanashi (JP)

(21) Appl. No.: 18/005,187

(22) PCT Filed: Jul. 30, 2021
(86) PCT No.: PCT/JP2021/028475

§ 371 Date: Jan. 12, 2023

(30) Foreign Application Priority Data
Aug. 5, 2020 (JP) 2020-133037

(51) Int. Cl. B25J 9/16; B25J 19/02

(52) U.S. Cl. CPC B25J 9/1666; B25J 9/161; B25J 9/1671; B25J 19/021

(57) ABSTRACT

This robot device comprises a robot including a plurality of constituent members, and a control device. The control device stores three-dimensional shape data of the constituent members of the robot. A setting unit of the control device sets some of the constituent members to determine interference in accordance with an operation state of the robot. A determination unit of the control device determines, on the basis of the three-dimensional shape data of the constituent members set by the setting unit, whether the constituent members of the robot interfere with a container storing a workpiece.

### TECHNICAL FIELD

The present invention relates to a robot device for detecting interference of a constituent member of a robot.

### BACKGROUND ART

A robot device including a robot and an operation tool is capable of performing a variety of operations by changing a position and an orientation of the robot. Surrounding objects associated with the operations are placed around the robot device. For example, a container for accommodating workpieces, a convey device for conveying a workpiece, or the like is disposed as a surrounding object. Alternatively, a fence may be disposed in order to define a work region of the robot device.

When the robot is driven, the robot or the operation tool may interfere with the surrounding objects. In order to check that the robot device does not interfere with the surrounding objects, a simulation device that simulates operation of the robot device can be used. The simulation device can generate a model representing the robot and a model representing the surrounding objects and determine the occurrence of interference when the robot is driven.

Based on a result of the simulation, an operator can determine the placement of the robot and the surrounding objects such that the robot device and the surrounding objects do not interfere with each other. In addition, the position and the orientation of the robot when the robot is driven can be determined such that the robot device and the surrounding objects do not interfere with each other. In particular, the operator can operate a teach pendant and actually drive the robot. The operator can perform teaching-playback (on-line teaching) for teaching the position and the orientation of the robot so that interference does not occur.

It should be noted that a robot device is known in which operation of a robot is not determined to one. For example, there is a case where a large number of workpieces are loaded in bulk on a case such as a container. For a robot device that takes out the workpiece loaded in bulk, a position and an orientation of a robot when gripping the workpiece are difficult to be taught because a state in which the workpieces are loaded cannot be predetermined. In the related art, a robot device for detecting the position and the orientation of a workpiece by using a vision sensor and taking out the workpiece from a case is known (e.g., Japanese Unexamined Patent Publication No. 2013-43271 A).

In the robot device for taking out the workpiece loaded in bulk, interference may be difficult to be avoided by the examination using the simulation device. To this end, a controller that images the surrounding objects by using a three-dimensional sensor and determines whether interference between the robot and the surrounding objects occurs when the robot device is actually driven is known (e.g., Japanese Unexamined Patent Publication No. 2020-28957 A). In such a controller, position data of the surrounding object that may cause interference with the robot is acquired in advance. The controller generates a model of the robot by using a plurality of column-shaped models or the like. The controller calculates the position and the orientation of the robot according to the position and the orientation of the workpiece and determines whether the robot interferes with the surrounding object.

### CITATION LIST

### Patent Literature

[PTL 1] Japanese Unexamined Patent Publication No. 2013-43271 A

[PTL 2] Japanese Unexamined Patent Publication No. 2020-28957 A

### SUMMARY OF INVENTION

### Technical Problem

In the robot device in which operation of the robot is determined according to a state or the like of the workpiece, it is difficult to predetermine the position and the orientation of the robot. Thus, the operator generates many positions and orientations of the robot when the robot device is driven by using the simulation device. The operator checks that interference does not occur by performing a large number of times of simulations using the various positions and the orientations of the robot. However, the number of times the simulation is performed is determined based on the experience of the operator. In general, when the robot device starts being actually used, the position and the orientation of the robot are finely adjusted with respect to the driving state of the robot device that has not been examined in the simulation. Therefore, the robot and the surrounding objects are often disposed in a manner such that sufficient allowance is made to avoid interference between the robot and the operation tool.

Furthermore, in order that a user other than the manufacturer of the robot determines whether the robot or the operation tool is interfering with surrounding objects when the controller drives the robot, there is a problem in that constituent members such as an arm of the robot need to be disassembled in order to three-dimensionally measure the shapes, or shape data of the constituent members of the robot needs to be obtained from the manufacturer of the robot. For this reason, the user performs the function by replacing the constituent members of the robot with models having simple shapes. For example, a model of the arm of the robot is formed by a model having a rectangular parallelepiped shape or a columnar shape. The model having the simple shape is generated so as to be larger than the constituent member of the actual robot in order to avoid interference between the robot and the surrounding objects. In other words, a large model is generated such that the constituent member of the robot is contained within the model. To this end, it may be determined by the controller that interference with the surrounding objects occurs, even in a case where the constituent member of the robot does not interfere with the surrounding objects when the robot is actually driven.

On the other hand, when the shape of the model of the constituent member of the robot is made close to the actual shape, a large amount of calculation for determining interference by using the model of the robot must be carried out, thereby there is a problem that it takes a considerable length of time in order to determine interference. Alternatively, in order to shorten the calculation time, it is necessary to use a computer with high performance.

### Solution to Problem

A robot device according to an aspect of the present disclosure includes a robot including a plurality of constituent members, and a controller configured to control the robot. The controller includes a storage part configured to store three-dimensional shape data of a constituent member of the robot. The controller includes a determination unit configured to determine whether the constituent member of the robot interferes with a workpiece or a surrounding object disposed around the robot when the robot is driven. The controller includes a setting unit configured to set one or more constituent members to be determined concerning interference according to an operating state of the robot among the plurality of constituent members of the robot. The determination unit determines whether the constituent member set by the setting unit interferes with the workpiece or the surrounding object based on the three-dimensional shape data of the constituent member set by the setting unit.

### Advantageous Effects of Invention

According to the aspect of the present disclosure, it is possible to provide a robot device for determining interference of the robot with a small calculation amount.

### BRIEF DESCRIPTION OF DRAWINGS

FIG. 1 is a perspective view of a robot device according to an embodiment.

FIG. 2 is a block diagram of the robot device according to the embodiment.

FIG. 3 is an explanatory diagram of three-dimensional shape data according to the embodiment.

FIG. 4 is a perspective view of models of a robot and a hand according to the embodiment.

FIG. 5 is a flowchart of control for conveying a workpiece according to the embodiment.

FIG. 6 is a perspective view of the robot and the hand for explaining control for searching for a position where interference is avoided.

FIG. 7 is a plan view of a region for explaining the position where interference is avoided.

FIG. 8 is a perspective view of the robot and the hand for explaining control for searching for an orientation where interference is avoided.

FIG. 9 is a schematic plan view of the hand for explaining the orientation where interference is avoided.

FIG. 10 is a perspective view of a model of the robot device with models of the hand and a conveyor simplified.

### DESCRIPTION OF EMBODIMENTS

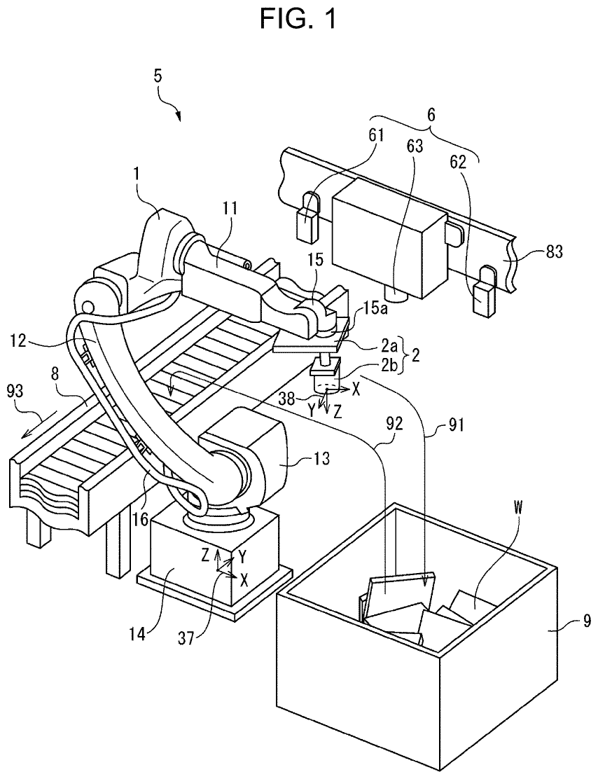

A robot device according to an embodiment will be described with reference to FIG. 1 to FIG. 10. In the present embodiment, the robot device that takes out workpieces highly piled up in a case and that conveys the workpieces to a conveyor will be cited as an example and be described.

FIG. 1 is a perspective view of the robot device according to the present embodiment. A robot device 5 includes a robot 1 and a hand 2 serving as an operation tool. The robot 1 according to the present embodiment is an articulated robot including a plurality of joints. The robot 1 includes an upper arm 11 and a lower arm 12. The lower arm 12 is supported by a turning base 13. The turning base 13 is supported by a base 14. The robot 1 includes a wrist 15 that is coupled to an end portion of the upper arm 11. The wrist 15 includes a flange 15a that is formed so as to be rotatable. The robot 1 includes a plurality of constituent members. In the present embodiment, the upper arm 11, the lower arm 12, the turning base 13, the base 14, and the wrist 15 are exemplified as the constituent members and described. Positions and orientations of the upper arm 11, the lower arm 12, the turning base 13, and the wrist 15 are changed by driving the robot. These constituent members rotate about predetermined rotation axes. The robot is not limited to the configuration, and any robot that can support an operation tool and move the operation tool can be employed.

The operation tool is formed so as to perform a predetermined operation on a workpiece. The hand 2 according to the present embodiment grips or releases a workpiece W. The hand 2 includes a main body 2a fixed to the flange 15a of the wrist 15, and an electromagnet 2b supported by the main body 2a. The electromagnet 2b generates an attraction force due to a magnetic force. The electromagnet 2b according to the present embodiment is formed so as to have a columnar shape. The workpiece W is attracted to the bottom surface of the electromagnet 2b.

The robot device 5 is provided with a conveyor 8 as a surrounding object disposed around the robot 1. The conveyor 8 is disposed near the robot 1. The workpiece W placed on the conveyor 8 is conveyed in a direction indicated by an arrow 93. The conveyor 8 according to the present embodiment is disposed at a position where the lower arm 12 may interfere with the conveyor 8 when the robot 1 changes the position and the orientation. That is, a part of the conveyor 8 is disposed within an operating range of the lower arm 12 of the robot 1.

The workpiece W according to the present embodiment is formed of a magnetic material such as iron. The workpiece W according to the present embodiment has a rectangular parallelepiped shape. The workpiece W includes a maximum area surface having a maximum area. The workpiece W is disposed inside a container 9 serving as a case. The container 9 corresponds to a surrounding object disposed around the robot 1. A plurality of workpieces W are loaded in bulk such that orientations of the workpieces W are irregular.

The robot device 5 includes a range sensor 6 serving as a three-dimensional sensor for detecting a position and an orientation of the workpiece W accommodated in the container 9. The range sensor 6 of the present embodiment is a stereo camera including two cameras 61 and 62. The cameras 61 and 62 are two-dimensional cameras that can capture a two-dimensional image. As the cameras 61 and 62, any cameras including image sensors such as a charge-coupled device (CCD) sensor or a complementary metal-oxide semiconductor (CMOS) sensor can be employed. The relative positions of the two cameras 61 and 62 are determined in advance. The range sensor 6 of the present embodiment includes a projector 63 that projects light in a pattern, such as a stripe pattern, toward the workpieces W.

The range sensor 6 acquires information about a distance to a measurement point set on the surface of an object. The range sensor 6 is disposed at a position where the workpiece W accommodated in the container 9 can be imaged. In the present embodiment, the range sensor 6 is disposed above the container 9. The range sensor 6 is supported by a support member 83. The range sensor 6 has an imaging range within which imaging can be performed. The cameras 61 and 62 are preferably disposed such that the container 9 is included within the imaging range.

The robot device 5 according to the present embodiment selects one workpiece W that will be taken out from the container 9 based on three-dimensional information generated from an output of the range sensor 6. In FIG. 1, the position and the orientation of the robot 1 are an initial position and an initial orientation that serve as a reference for starting the taking-out. As indicated by an arrow 91, the robot device 5 changes the position and the orientation of the robot 1 and grips the workpiece W disposed inside the container 9. The robot device 5 changes the position and the orientation of the robot 1 as indicated by an arrow 92 and conveys the workpiece W from the inside of the container 9 to the conveyor 8. Then, the robot 1 returns to the initial position and the initial orientation serving as the reference.

A reference coordinate system 37 that is immovable when the position and the orientation of the robot 1 change is set for the robot device 5 according to the present embodiment. In the example illustrated in FIG. 1, the origin of the reference coordinate system 37 is disposed at the base 14 of the robot 1. The reference coordinate system 37 is also referred to as a world coordinate system. In addition, for the robot device 5, a tool coordinate system 38 that has the origin set at any position of the operation tool is set. The position and the orientation of the tool coordinate system 38 change together with the hand 2. The origin of the tool coordinate system 38 according to the present embodiment is set at a tool tip point.

Each coordinate system of the reference coordinate system 37 and the tool coordinate system 38 has an X axis, a Y axis, and a Z axis that are orthogonal to each other as coordinate axes. Additionally, a W axis, a P axis, and an R axis are set as coordinate axes respectively about the X axis, Y axis, and Z axis.

When the position and the orientation of the robot 1 change, the position and the orientation of the origin of the tool coordinate system 38 change. For example, the position of the robot 1 corresponds to a position of the tool tip point (the position of the origin of the tool coordinate system 38). Furthermore, the orientation of the robot 1 corresponds to the orientation of the tool coordinate system 38 with respect to the reference coordinate system 37.

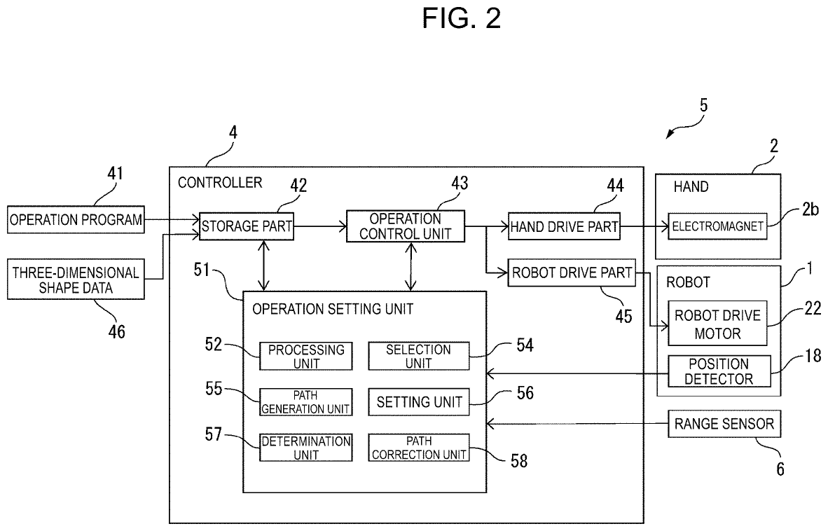

FIG. 2 is a block diagram of the robot device according to the present embodiment. Referring to FIG. 1 and FIG. 2, the robot 1 includes a robot drive device that changes the position and the orientation of the robot 1. The robot drive device includes a robot drive motor 22 for driving each of constituent members such as an arm and a wrist. The robot device 5 includes a hand drive device that drives the hand 2. The workpiece W is attracted to the electromagnet 2b when the electromagnet 2b of the hand 2 is driven. The bottom surface of the electromagnet 2b according to the present embodiment is a flat surface. The bottom surface of the electromagnet 2b attracts a main surface whose area is maximum in the workpiece W.

The robot device 5 includes a controller 4 that controls the robot 1 and the hand 2. The controller 4 includes an arithmetic processing device (computer) that includes a central processing unit (CPU) as a processor. The controller 4 includes a random access memory (RAM), a read only memory (ROM), and the like, connected to the CPU via a bus. The controller 4 includes a storage part 42 that stores information regarding control of the robot 1 and the hand 2. The storage part 42 can be configured of a storage part medium capable of storing information, such as a volatile memory, a nonvolatile memory, or a hard disk.

The robot device 5 conveys the workpiece W based on an operation program 41. The controller 4 includes an operation control unit 43 that sends an operation command. The operation control unit 43 corresponds to a processor driven according to the operation program 41. The processor reads the operation program 41 and performs the control specified in the operation program 41, thereby functioning as the operation control unit 43.

The operation control unit 43 sends an operation command for driving the robot 1 to a robot drive part 45 based on the operation program 41. The robot drive part 45 includes an electrical circuit for driving the robot drive motor 22. The robot drive part 45 supplies electricity to the robot drive motor 22 based on the operation command. Further, the operation control unit 43 sends an operation command for driving the hand 2 to a hand drive part 44 based on the operation program 41. The hand drive part 44 includes an electrical circuit that drives the electromagnet 2b. The hand drive part 44 supplies electricity to the electromagnet 2b based on the operation command. Further, the operation control unit 43 sends an operation command for performing imaging to the range sensor 6 based on the operation program 41. The range sensor 6 is controlled by the controller 4.

The controller 4 according to the present embodiment includes an operation setting unit 51 that sets operation of the robot 1 based on the operation program 41. The operation control unit 43 generates an operation command based on a command from the operation setting unit 51. The operation setting unit 51 according to the present embodiment performs control for selecting the workpiece W that will be taken out from the container 9 and gripping the workpiece W with the hand 2. Further, the operation setting unit 51 performs control for conveying the workpiece W gripped with the hand 2 to the conveyor 8.

The operation setting unit 51 includes a processing unit 52 that generates three-dimensional information about the workpieces W based on an output from the range sensor 6. Three-dimensional information about an object corresponds to three-dimensional shape data of the object. Furthermore, the processing unit 52 detects the positions and the orientations of the workpieces W disposed in the container 9. The operation setting unit 51 includes a selection unit 54 that selects the workpiece W that will be taken out from the container 9. The operation setting unit 51 includes a path generation unit 55 that generates a path of the robot 1. The operation setting unit 51 includes a setting unit 56 that sets some members for which interference is determined according to the operating state of the robot 1. The operation setting unit 51 includes a determination unit 57 that determines whether interference occurs when the robot 1 is driven. The operation setting unit 51 includes a path correction unit 58 that corrects the position and the orientation of the robot 1 so that the interference does not occur when it is determined that interference may occur.

The operation setting unit 51 corresponds to a processor that is driven according to the operation program 41. In particular, each unit of the processing unit 52, the selection unit 54, the path generation unit 55, the setting unit 56, the determination unit 57, and the path correction unit 58 that are included in the operation setting unit 51 corresponds to a processor that is driven according to the operation program 41. The processor functions as each unit by reading the operation program 41 and performing the control that is defined by the operation program 41.

The robot 1 includes a state detector for detecting the position and the orientation of the robot 1. The state detector of the present embodiment includes a position detector 18 attached to the robot drive motor 22 corresponding to the drive axis of each of the constituent members such as the arm. The position and the orientation of the robot 1 are calculated based on a rotation angle output from each position detector 18.

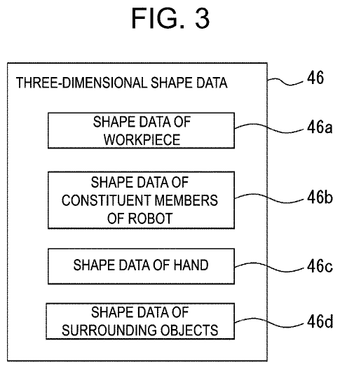

FIG. 3 is an explanatory diagram of three-dimensional shape data stored in the controller according to the present embodiment. With reference to FIG. 2 and FIG. 3, in the present embodiment, three-dimensional shape data 46 is input to the controller 4 before the robot device 5 is driven. The storage part 42 stores the three-dimensional shape data 46. As the three-dimensional shape data 46, any data indicating a three-dimensional shape of each member can be employed.

The three-dimensional shape data 46 includes shape data 46a of a workpiece. The shape data 46a of the workpiece is used in order to detect the position and the orientation of the workpiece W disposed in the container 9. The three-dimensional shape data 46 includes shape data 46b of the constituent members of the robot and shape data 46c of the hand. The shape data 46b of the constituent members of the robot and the shape data 46c of the hand are used in order to determine interference between the constituent members of the robot 1 or the hand 2 and other objects. Three-dimensional data generated in a computer aided design (CAD) device is employed as the shape data 46a of the workpiece, the shape data 46b of the constituent members of the robot, and the shape data 46c of the hand according to the present embodiment. In particular, data generated by the CAD device at the time of designing by the manufacturer is employed as the shape data 46b of the constituent members of the robot and the shape data 46c of the hand. The data generated by the CAD device at the time of designing matches with the shapes of the actual members. In other words, the data at the time of designing corresponding to the actual shapes is employed without using three-dimensional shape data having a simple shape such as a quadrangular prism or a cone. Note that a portion that is not related to interference of the constituent members may be excluded from the design data. For example, a fine portion such as a recess that is formed on the surface of the constituent member and that is for disposing the head of a bolt may be excluded from the design data.

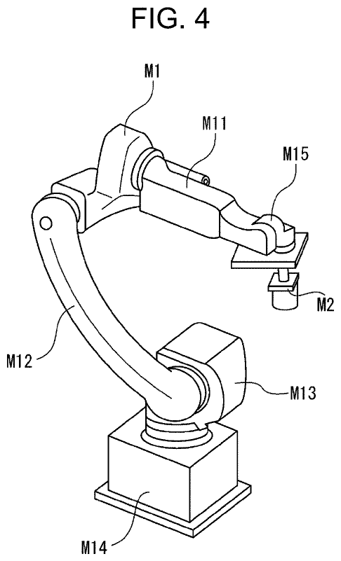

FIG. 4 is a perspective view of models of the robot and the hand according to the present embodiment. The operation setting unit 51 generates models of the constituent members of the robot and a model of the hand from the shape data 46b of the constituent members of the robot and the shape data 46c of the hand. Models having the same shapes as the shapes of the design data at the time of designing the robot 1 and the hand 2 are generated.

A model M1 of the robot includes models of a plurality of constituent members. The model M1 of the robot includes a model M11 of the upper arm, a model M12 of the lower arm, a model M13 of the turning base, a model M14 of the base, and a model M15 of the wrist. In the present embodiment, the model of each constituent member of the robot 1 matches the shape of the actual constituent member. For example, even for a fine portion such as a curved surface, a step, and a projection of the constituent member of the robot 1, the model has a matching shape with the shape of the actual robot 1. A model M2 of the hand also has a matching shape with the shape of the actual hand 2 even for the fine portion. Note that, as described above, a fine portion of the constituent member such as a recess that is not related to interference may be excluded.

Note that, with reference to FIG. 1, the robot 1 according to the present embodiment includes an electric cable 16 disposed outside the upper arm 11 and the lower arm 12. When the position and orientation of the robot 1 change, the shape of the electric cable 16 changes. Due to this, with reference to FIG. 4, the electric cable 16 is excluded from the model M1 of the robot according to the present embodiment, but the embodiment is not limited thereto. Models of members such as an electric cable and a pipe of the robot 1 may also be generated.

With reference to FIG. 2 and FIG. 3, the three-dimensional shape data 46 includes shape data 46d of the surrounding objects disposed around the robot 1. The shape data 46d of the surrounding objects is used in order to determine interference between the surrounding objects and the robot 1 or the hand 2. In the present embodiment, the shape data 46d of the surrounding objects includes shape data of the conveyor 8 and shape data of the container 9. Three-dimensional data generated by using the CAD device can be employed as the shape data 46d of the surrounding objects.

The surrounding objects are not limited to the conveyor and the container, and any obstacles that may cause interference with the robot or the operation tool and that are disposed around the robot may be employed as the surrounding objects. For example, a fixed object such as a platform where a workpiece is placed or a fence disposed around the robot device can be employed as the surrounding object. Alternatively, a moving object such as a conveying vehicle that passes near the robot may be employed as the surrounding object.

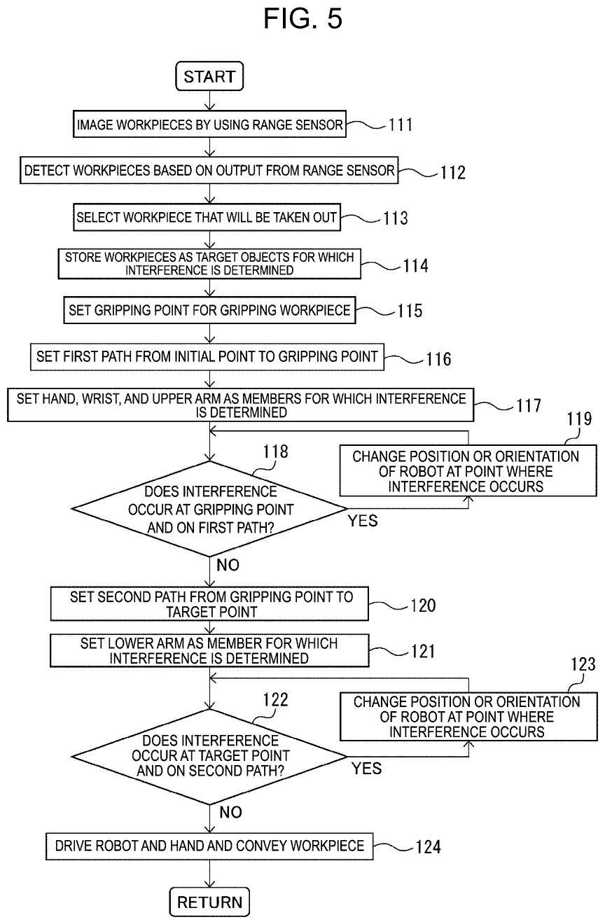

FIG. 5 is a flowchart of control for the robot device according to the present embodiment. In FIG. 5, the control for conveying one workpiece W is illustrated. The control illustrated in FIG. 5 can be repeatedly performed every time a single workpiece W is taken out. With reference to FIG. 2 and FIG. 5, as described above, the three-dimensional shape data 46 of the robot device and the surrounding objects is stored in the storage part 42 in advance.

First, the operation setting unit 51 sets the position and the orientation of the robot 1 to an initial position and an initial orientation when taking-out of the workpiece W is started (see FIG. 1). In the present embodiment, a movement point of the robot 1 at this time is referred to as an initial point. The operator can predetermine the initial position and the initial orientation at the initial point. The initial point is determined such that the robot 1 and the hand 2 are not disposed in the imaging range of the range sensor 6, for example.

In step 111, the range sensor 6 images the workpieces W inside the container 9. The processing unit 52 in the operation setting unit 51 processes the images captured by the cameras 61 and 62. The processing unit 52 generates three-dimensional information about the workpieces W by a stereo method. The processing unit 52 sets a measurement point at the surface of the workpiece W. The processing unit 52 calculates a distance from the range sensor 6 to a measurement point based on parallax between the two images captured by the two cameras 61 and 62. The processing unit 52 detects a position of the measurement point based on the distance from the range sensor 6 to the measurement point. The three-dimensional information includes information about positions of a plurality of measurement points set on the surface of the object.

For example, the three-dimensional information is a distance image or a three-dimensional map and corresponds to three-dimensional shape data. The distance image is an image with a color or density changed according to the distance from the range sensor 6. The three-dimensional map includes coordinate values of a measurement point in a predetermined coordinate system or information as to the distance from the range sensor to the measurement point and the direction of the measurement point.

In step 112, the processing unit 52 performs template matching for comparing the three-dimensional information about the workpieces W with the shape data 46a of the workpiece W and detects the positions and the orientations of the workpieces W accommodated in the container 9. Note that the three-dimensional data generated by the CAD device is employed as the shape data of the workpiece according to the present embodiment, but the embodiment is not limited thereto. The operator may employ a distance image when the workpiece is imaged from various directions as the shape data of the workpiece.

Alternatively, the processing unit 52 may use a two-dimensional image in the detection of the workpieces W. The two-dimensional image is captured by using one camera of the two cameras 61 and 62 of the range sensor 6. The workpieces are detected in the two-dimensional image by template matching with the two-dimensional image. Then, the processing unit 52 selects one workpiece and acquires the three-dimensional information about a region corresponding to the surface of the workpiece W. For example, the processing unit 52 can calculate a flat surface by using a plurality of measurement points corresponding to the surface of the workpiece W, and calculate the position and the orientation of the workpiece W.

In step 113, the selection unit 54 selects a target workpiece W that will be taken out by the robot device 5. The selection unit 54 selects the target workpiece W based on the positions and the orientations of the workpieces W detected by the processing unit 52. The selection unit 54 can select the target workpiece W by any control. For example, the selection unit 54 can set the workpiece W closest to the range sensor 6 as the target workpiece W. Thus, the selection unit 54 can select the workpieces W one by one in the order of the highest position of the workpiece W.

In step 114, the storage part 42 stores the three-dimensional information about the workpieces W except for the workpiece W that will be taken out by the robot device 5 in the storage part 42. The workpieces W except for the workpiece W that will be taken out by the robot device 5 serve as objects that interfere with the robot 1 or the hand 2. The three-dimensional information is used for control for determining whether interference occurs with the robot 1 or the hand 2.

In step 115, the path generation unit 55 sets a gripping point that is a point where the robot 1 grips the workpiece W according to the position and the orientation of the target workpiece W. The path generation unit 55 calculates a gripping position and a gripping orientation of the robot 1 at the gripping point.

In step 116, the path generation unit 55 generates a first path of the robot 1 from the initial point to the gripping point where the workpiece W is gripped. In FIG. 1, a path indicated by the arrow 91 corresponds to the first path. Control for generating the first path by the path generation unit 55 can be adopted with various path search algorithms so that the robot 1 or the hand 2 does not interfere with the workpiece W in view of the three-dimensional shape of the robot 1 or the hand 2. The path generation unit 55 can generate a plurality of movement points through which the position of the robot 1 passes. The path passing through the plurality of movement points corresponds to the first path. In addition, interpolation points may be set between every two of the plurality of movement points. At this time, the path generation unit 55 can generate the first path without taking into account interference between the hand 2 or the robot 1 and other objects.

Next, in step 117, the setting unit 56 sets members for which interference is determined among the plurality of constituent members of the robot 1 and the hand 2. In the example here, the setting unit 56 sets the wrist 15 and the upper arm 11 among the plurality of constituent members of the robot 1 as the constituent members for which interference is determined. Furthermore, the setting unit 56 sets the hand 2 as the member for which interference is determined.

The setting unit 56 sets the member for which interference is determined according to the operating state of the robot 1. With reference to FIG. 1, when the position of the robot 1 moves along the first path as indicated by the arrow 91, the hand 2 and the wrist 15 are inserted inside the container 9. In addition, the upper arm 11 is disposed near the container 9. The hand 2, the wrist 15, and the upper arm 11 may come into contact with the container 9. For this reason, the hand 2, the wrist 15, and the upper arm 11 can be set as the members for which interference is determined. Further, the setting unit 56 can set the container 9 and the workpiece W as the members for which interference is determined. The members for which interference is determined can be predetermined in the operation program 41, for example. The setting unit 56 reads the operation program 41 and then sets the members for which interference is determined.

Next, in step 118, the determination unit 57 determines whether interference occurs at the gripping point and on the first path. The determination unit 57 determines whether the members set by the setting unit 56 interfere with the workpieces or the surrounding objects based on the three-dimensional shape data of the members set by the setting unit 56, the three-dimensional information about the workpieces, and the three-dimensional shape data of the surrounding objects. Note that positions where the surrounding objects are disposed are predetermined.

First, the determination unit 57 determines whether the hand 2, the wrist 15, and the upper arm 11 interfere with the container 9 or the workpieces W except for the workpiece W that will be gripped by the robot device 5 when the robot 1 is at the gripping position and in the gripping orientation for gripping the workpiece W.

The determination unit 57 acquires the gripping position and the gripping orientation of the robot 1. Further, the determination unit 57 calculates positions and orientations of the models of the constituent members of the robot device 5 based on the gripping position and the gripping orientation of the robot 1. The determination unit 57 calculates the positions and the orientations of the models based on information about the respective drive axes of the constituent members. Here, the determination unit 57 calculates the positions and the orientations of the model M2 of the hand, the model M15 of the wrist, and the model M11 of the upper arm. The position and the orientation of each model can be expressed, for example, by using the reference coordinate system 37.

Furthermore, the determination unit 57 acquires the three-dimensional shape data of the container 9 and the three-dimensional information about the workpieces. Here, the determination unit 57 may generate the model of the container and the model of the workpiece based on the three-dimensional shape data of the container and the three-dimensional information about the workpieces. The model of the container or the model of the workpiece can also be expressed, for example, by using the reference coordinate system 37.

The determination unit 57 can determine that interference occurs when the model M2 of the hand, the model M15 of the wrist, and the model M11 of the upper arm are disposed at positions where these members come into contact with the container 9 or the workpieces W except for the workpiece W that will be gripped.

Next, the determination unit 57 determines whether interference occurs when the position of the robot 1 moves along the first path. The determination unit 57 acquires the movement points generated by the path generation unit 55. Furthermore, the determination unit 57 acquires the interpolation points generated between every two of the movement points. The determination unit 57 calculates the position and the orientation of the robot 1 at each of the movement points and the interpolation points. In a similar manner to the control of the determination at the gripping point, the determination unit 57 determines whether the model M2 of the hand, the model M15 of the wrist, and the model M11 of the upper arm interfere with the container 9 or the workpieces W except for the workpiece W that will be gripped at each of the movement points and the interpolation points.

In step 118, the control proceeds to step 119 when the constituent members of the robot 1 are determined to interfere with the workpieces or the surrounding objects at the gripping point and on the first path. Also, when the hand 2 is determined to interfere with the workpieces or the surrounding objects at the gripping point and on the first path, the control proceeds to step 119.

In step 119, the path correction unit 58 corrects the position or the orientation of the robot 1 at the point where interference occurs among the gripping point, the movement points, and the interpolation points. Alternatively, the path correction unit 58 may correct both the position and the orientation of the robot 1. Here, a method for correcting the position and a method for correcting the orientation of the robot 1 at the gripping point, the movement points, or the interpolation points will be described.

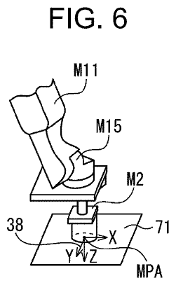

FIG. 6 is a perspective view of the model of the hand and the model of the robot for describing the method for correcting the position of the robot. In the example here, it is determined that interference occurs when the position of the robot 1 is disposed at a movement point MPA. Thus, the path correction unit 58 corrects the position of the robot 1. The path correction unit 58 sets a region 71 for moving the movement point MPA around the movement point MPA. A shape and a size of the region 71 can be predetermined. In the present embodiment, the region 71 having a square shape is set in a plane including the X axis and the Y axis of the tool coordinate system 38.

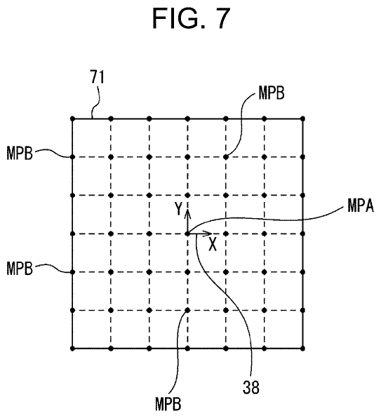

FIG. 7 is a plan view of the region for moving the position of the movement point. In the present embodiment, the region 71 is set at a predetermined distance in the X axis direction and the Y axis direction of the tool coordinate system 38 from the movement point MPA. The path correction unit 58 searches for a movement point MPB where interference can be avoided within the region 71. The path correction unit 58 equally divides the region 71 in the X axis direction and the Y axis direction. The movement point MPB can be set at a vertex of a small region when the region 71 is divided. In the example described here, the region is divided into six in the X axis direction and divided into six in the Y axis direction. The movement points MPB of 48 points are set around the movement point MPA.

The path correction unit 58 determines whether interference occurs for the model M2 of the hand, the model M15 of the wrist, and the model M11 of the upper arm when the position of the robot 1 is moved to each of the movement points MPB. The path correction unit 58 can determine interference for all of the movement points MB.

The path correction unit 58 can set the movement point MPB at which interference is avoided as a movement point after correction. When there are a plurality of movement points MPB at which interference is avoided, the path correction unit 58 can select one movement point MPB based on a predetermined priority. For example, the path correction unit 58 can employ the movement point MPB closest to the original movement point MPA. Furthermore, a priority of the positive direction or the negative direction of the X axis can be determined. Furthermore, a priority of the positive direction or the negative direction of the Y axis can be determined.

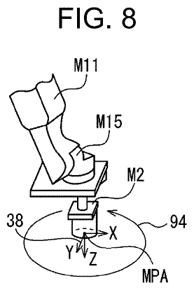

FIG. 8 is a perspective view of the model of the hand and the model of the robot when the orientation of the robot is corrected at the movement point. The path correction unit 58 changes the orientation of the robot 1 and searches for the orientation in which interference can be avoided. In the example here, the path correction unit 58 rotates the model M2 of the hand around the Z axis of the tool coordinate system 38, i.e., the R axis direction. The path correction unit 58 changes the orientation of the robot by rotating the model M2 of the hand in the direction indicated by an arrow 94.

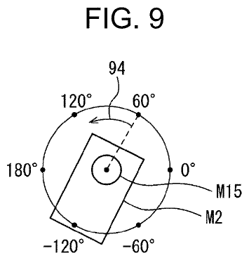

FIG. 9 is a plan view when the model of the hand rotates. The path correction unit 58 according to the present embodiment rotates the model M2 of the hand by each of predetermined angles. In the example here, rotation angles obtained by dividing a single rotation by six are set. The path correction unit 58 calculates the positions and the orientations of the hand 2, the wrist 15, and the upper arm 11 at all of the rotation angles and determines whether interference may occur or not.

The path correction unit 58 can set the orientation of the robot 1 for which interference will be avoided to an orientation after correction. When there are a plurality of orientations in which interference can be avoided, the path correction unit 58 can select one orientation by any control. For example, the path correction unit 58 can employ the rotation angle closest to the original rotation angle. In addition, a priority of a clockwise direction or a counterclockwise direction when the hand is rotated can be predetermined.

In a case where interference cannot be avoided even when either of the position of the robot or the orientation of the robot is changed, the path correction unit 58 can change the other. In the present embodiment, in a case where interference cannot be avoided even when the orientation of the robot is changed, the position of the robot is changed.

With reference to FIG. 5, in this way, in step 119, the position or the orientation of the robot at the point where interference occurs is changed. The path correction unit 58 can employ the position and the orientation of the robot after the correction and generate a new first path. Then, the control can proceed to step 118 and determine whether interference occurs. The control of step 118 and step 119 can be repeated until no interference occurs at the gripping point and on the first path.

In step 118, when no interference occurs at the gripping point and on the first path, the position and the orientation of the robot 1 at the gripping point and on the first path are confirmed. In this case, the control proceeds to step 120. Next, a second path for conveying the workpiece W to the conveyor 8 is generated.

In step 120, the path generation unit 55 generates the second path from the gripping point to a target point for placing the workpiece W on the conveyor 8. With reference to FIG. 1, the path indicated by the arrow 92 corresponds to the second path. The path generation unit 55 can generate the second path by control in a similar control for generating the first path in step 116.

Next, in step 121, the setting unit 56 sets a member for which interference is determined according to the operating state of the robot 1. With reference to FIG. 1, the lower arm 12 may interfere with the conveyor 8 when the robot device 5 conveys the workpiece W to the conveyor 8 after gripping the workpiece W. In this operating state, interference of the lower arm 12 is determined. The setting unit 56 sets the lower arm 12 as a member for which interference is determined, based on description of the operation program 41. Further, the setting unit 56 sets the conveyor 8 as the member for which the interference is determined based on the description of the operation program 41.

In step 122, the determination unit 57 determines whether interference between the lower arm 12 and the conveyor 8 occurs at the target point and on the second path by control similar to that in step 118. The determination unit 57 determines whether interference between the lower arm 12 and the conveyor 8 occurs based on the model M12 of the lower arm and the three-dimensional shape data of the conveyor 8.

In step 122, when it is determined that the interference occurs at the target point and on the second path, the control proceeds to step 123. In step 123, the path correction unit 58 corrects the position or the orientation of the robot 1 by control similar to the control for correcting the position of the robot 1 or the control for correcting the orientation of the robot 1 in step 119. Then, the control of step 122 and step 123 is repeated until no interference between the lower arm 12 and the conveyor 8 occurs. In step 122, when it is determined that no interference occurs at the target point and on the second path, the position and the orientation of the robot 1 at the target point and on the second path are confirmed. The control proceeds to step 124.

In step 124, the operation setting unit 51 sends the positions and the orientations of the robot 1 at the gripping point and the target point, and on the first path and the second path to the operation control unit 43. The position of the robot 1 is moved along the first path. The robot 1 changes the position and the orientation to the gripping position and the gripping orientation. The workpiece W can be gripped by exciting the electromagnet 2b of the hand 2 after the robot 1 reaches the gripping position and the gripping orientation.

Next, the position of the robot 1 is moved along the second path. The operation control unit 43 changes the position and the orientation of the robot 1 and conveys the workpiece W to the target point where the workpiece W is placed on the conveyor 8. The workpiece W is released by stopping the excitation of the electromagnet 2b of the hand 2 after the robot 1 reaches the target position and the target orientation. Then, the robot 1 returns to the initial position and the initial orientation.

In the robot device 5 according to the present embodiment, when interference is determined, some constituent members are selected from the plurality of constituent members of the robot 1 according to the operating state of the robot 1. In other words, the controller 4 switches the constituent members for which interference is determined according to the operating state of the robot 1. In addition, the controller 4 determines interference based on the three-dimensional shape data of some constituent members. This can allow accurate determination in a short time. For example, when the three-dimensional shape data of all the constituent members of the robot 1 is used and interference with other objects is determined, the calculation amount increases, and the calculation time increases. However, in the present embodiment, the calculation amount of the determination of interference can be reduced by selecting some constituent members according to the operating state. Further, by using the shape data matching the shapes of the constituent members of the robot 1, the interference of the robot 1 can be accurately determined.

Furthermore, in the present embodiment, the three-dimensional shape data matching the actual shape of the hand 2 is employed as the model M2 of the hand 2. Thus, the interference of the hand 2 can be accurately determined.

In the present embodiment, the interference of the hand is determined in addition to determining the interference of the constituent members of the robot, but the embodiment is not limited thereto. It is not necessary to determine the interference of the hand. For example, when the shape of the hand does not cause interference with the container and the workpieces, it is not necessary to determine the interference of the hand. Furthermore, the robot device does not necessarily include the operation tool. For example, the robot device may include a device for automatically exchanging operation tools. There is a case where the robot changes the position and the orientation in a state where the operation tool is not attached to the robot in order to exchange the operation tools. During this period, the controller can determine interference of the constituent members of the robot without determining interference of the operation tool. In addition, in the present embodiment, interference is determined at the gripping point and the target point where the drive of the robot temporarily stops, and interference is determined on the first path and the second path. However, the embodiment is not limited thereto. On the first path and the second path, interference does not need to be determined.

The operation setting unit 51 according to the present embodiment generates the three-dimensional information about the workpieces W except for the workpiece W that will be taken out by the robot device 5, by using the range sensor 6. In other words, the three-dimensional information about the workpieces W remaining in the container 9 is generated. Then, the operation setting unit 51 determines whether the hand 2 or the constituent members of the robot 1 interfere with the workpieces W by using the three-dimensional information about the workpieces W. In some cases, the target workpiece W cannot be gripped because the workpieces W disposed in the container 9 interfere with the main body 2a of the hand 2 or the wrist 15. The robot device 5 according to the present embodiment can determine interference between the workpieces W disposed around the workpiece W that will be taken out by the robot device 5 and the hand 2 or the robot 1.

In the present embodiment, models having shapes matching the actual shapes are generated by employing the three-dimensional shape data generated by the CAD device for the surrounding objects such as the container 9. The method for generating the models of the surrounding objects is not limited to this embodiment. The operation setting unit may image the surrounding objects by using a three-dimensional sensor and generate the three-dimensional shape data of the surrounding objects based on the output of the three-dimensional sensor.

For example, the operation setting unit 51 can generate the three-dimensional information about the container 9 by a method for model matching based on the output of the range sensor 6. The operation setting unit 51 generates the three-dimensional information about the container 9 as the shape data 46d of the surrounding object. The operation setting unit 51 may determine whether interference between the robot 1 and the container 9 may occur based on the three-dimensional information about the container 9. This control is suitable for a case where the surrounding object moves.

In addition, when the surrounding object moves in one direction, a two-dimensional sensor can be employed instead of the three-dimensional sensor. The three-dimensional shape data of the surrounding object can be stored in the storage part in advance. The surrounding object is disposed at predetermined positions and reference images are captured by using the two-dimensional sensor. When the surrounding object moves, the surrounding object is imaged by using the two-dimensional sensor and a position of the surrounding object in the image is detected. A position of the surrounding object can be detected based on the position of the surrounding object in the image at this time and the position of the surrounding object in the reference image.

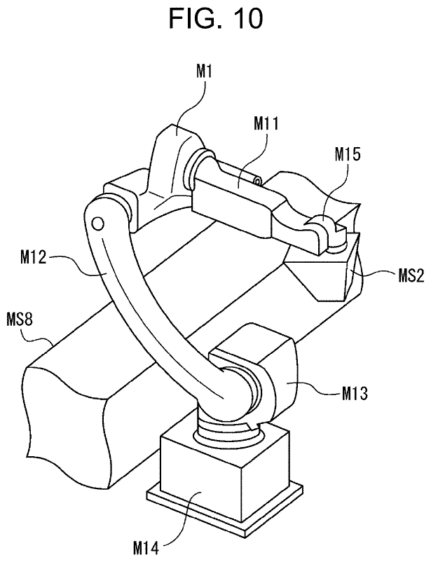

FIG. 10 is a perspective view of a model of the robot device including a model in which the shape of the operation tool is simplified and a model in which the shape of the conveyor is simplified. At least one model among the model of the operation tool and the model of the surrounding object may employ a model having a simplified shape.

The manufacturer has design data generated by the CAD device (three-dimensional shape data) when designing the robot 1. For this reason, the manufacturer can store the shape data 46b of the constituent members of the robot (the model M1 of the robot) in the storage part 42 at the time of manufacturing the robot 1. On the other hand, the operator may purchase a surrounding object such as an operation tool or a conveyor from a manufacturer different from the manufacturer of the robot. At this time, the operator cannot obtain design data of the operation tool or the surrounding object from the manufacturer, in some cases.

In such a case, the operator may employ at least one model among a model of the operation tool having a shape in which the shape of the operation tool is simplified and a model of the surrounding object having a shape in which the shape of the surrounding object is simplified. The operator can create the simple model and store the simple model in the storage part 42. The determination unit 57 determines whether interference of the member set by the setting unit 56 may occur by using at least one model among the model of the operation tool and the model of the surrounding object.

In the example illustrated in FIG. 10, a model MS2 of the hand has a truncated square pyramid shape. A model MS8 of the conveyor has a rectangular parallelepiped shape. Such a simple model can be easily generated by the operator by specifying the shape and the size. For example, the operator can generate the model MS8 of the conveyor by specifying the length of each side of the rectangular parallelepiped. As a shape of the simple model, any shape such as a column, a hexahedron, or a sphere can be employed. Also, the simple model is preferably formed so as to be large such that the actual device is contained therein. As described above, the operator may employ the simple models as the model of the operation tool and the model of the surrounding object.

In the embodiment described above, the upper arm 11, the lower arm 12, the turning base 13, the base 14, and the wrist 15 are exemplified as the constituent members of the robot 1, but the embodiment is not limited thereto. A constituent member of the robot may be a part of the arm, a part of the turning base, a part of the base, or a part of the wrist. In other words, any portion constituting the robot can be selected as the constituent member of the robot. For example, the controller may store the three-dimensional shape data of a part of the upper arm and determine whether interference with the workpieces or the surrounding objects may occur based on the shape data.

In addition, in the present embodiment, the three-dimensional shape data of all the constituent members of the robot is formed so as to match the actual shapes, but the embodiment is not limited thereto. The three-dimensional shape data of some constituent members of the robot may be formed so as to match the actual shapes, and the three-dimensional shape data of other constituent members may be data having simple shapes. Furthermore, the three-dimensional shape data of at least some constituent members of the robot may be data of simple shapes such as a quadrangular prism.

The range sensor 6 as the three-dimensional sensor according to the present embodiment includes the projector, but the projector is not necessarily provided. Furthermore, as the three-dimensional sensor, any sensor that can acquire three-dimensional information about the surface of a workpiece can be employed. For example, a time-of-flight (TOF) camera that captures a distance image by a time-of-flight scheme, a line sensor, or the like can be employed.

The range sensor 6 according to the present embodiment is fixed to the support member 83, but the embodiment is not limited thereto. The three-dimensional sensor can be disposed such that the workpiece can be imaged. For example, the three-dimensional sensor may be fixed to the wrist so as to move integrally with the wrist of the robot.

The robot device according to the present embodiment performs a task of conveying a workpiece, but the embodiment is not limited thereto. The control according to the present embodiment can be applied to a robot device that performs any operation. Any device that performs a predetermined operation on the workpiece can be employed as the operation tool. In particular, the control according to the present embodiment is suitable for a robot device in which the position and the orientation of a robot are changed according to a state of workpieces or a state of surrounding objects. For example, the control according to the present embodiment can be applied to a robot device that puts workpieces on the upper surface of a pallet or the like in an aligned manner.

In each of the above-described control operations, the order of steps can be changed appropriately to the extent that the function and the effect are not changed.

The above-described embodiments can be suitably combined. In each of the above-described drawings, the same or similar parts are denoted by the same reference numerals. It should be noted that the above-described embodiments are examples and do not limit the invention. Further, the embodiments include modifications of the embodiments recited in the claims.

### REFERENCE SIGNS LIST

1 robot
2 hand
4 controller
5 robot device
6 range sensor
8 conveyor
9 container
11 upper arm
12 lower arm
13 turning base
14 base
15 wrist
42 storage part
46 three-dimensional shape data
46a shape data of workpiece
46b shape data of constituent members of robot
46c shape data of hand
46d shape data of surrounding objects
52 processing unit
56 setting unit
57 determination unit

1. A robot device comprising:
a robot including a plurality of constituent members; and
a controller configured to control the robot, wherein
the controller includes
a storage part configured to store three-dimensional shape data of a constituent member of the robot,
a determination unit configured to determine whether the constituent member of the robot interferes with a workpiece or a surrounding object disposed around the robot when the robot is driven, and
a setting unit configured to set one or more constituent members to be determined concerning interference according to an operating state of the robot among the plurality of constituent members of the robot, and
the determination unit determines whether the constituent member set by the setting unit interferes with the workpiece or the surrounding object based on the three-dimensional shape data of the constituent member set by the setting unit.

2. The robot device according to claim 1, wherein
the three-dimensional shape data of the constituent member of the robot is formed in a manner for matching an actual shape.

3. The robot device according to claim 1, further comprising an operation tool configured to perform an operation on the workpiece, wherein
the robot is configured to move the operation tool, and
the controller controls the operation tool.

4. The robot device according to claim 3, wherein
the storage part stores three-dimensional shape data matching an actual shape of the operation tool,
the setting unit sets a member for which interference is determined among the plurality of constituent members of the robot and the operation tool according to the operating state of the robot, and
the determination unit determines whether the member set by the setting unit interferes with the workpiece or the surrounding object, based on the three-dimensional shape data of the member set by the setting unit.

5. The robot device according to claim 1, wherein
the determination unit calculates a position and an orientation of the robot on a path where the position of the robot moves, and determines interference of a member set by the setting unit based on the position and the orientation of the robot.

6. The robot device according to claim 3, wherein
the storage part stores at least one model among a model of the operation tool having a shape obtained by simplifying a shape of the operation tool and a model of the surrounding object having a shape obtained by simplifying a shape of the surrounding object, and
the determination unit determines interference of the member set by the setting unit by using the at least one model among the model of the operation tool and the model of the surrounding object.

7. The robot device according to claim 1, further comprising a three-dimensional sensor configured to acquire three-dimensional shape data including information about a position of a measurement point set on a surface of an object, wherein
the controller includes a processing unit configured to generate three-dimensional shape data of the workpiece based on an output of the three-dimensional sensor, and
the determination unit determines whether the constituent member of the robot set by the setting unit interferes with the workpiece, based on the three-dimensional shape data of the workpiece.
